(19) United States
(12) Patent Application Publication
(10) Pub. No.: US 2005/0053798 A1
(43) Pub. Date: Mar. 10, 2005

(54) Support material for three-dimensional laminating molding

(76) Inventors: Tsutomu Maekawa, Hitachinaka-shi (JP); Akemi Ouchi, Hitachinaka-shi (JP); Hidetoshi Fujii, Hitachinaka-shi (JP); Kunihiro Tamahashi, Hitachinaka-shi (JP)

Correspondence Address: Whitham Curtis and Christofferson, PC, Suite #340, 11491 Sunset Hills Rd., Reston, VA, 20190, US

(21) Appl. No.: 10/932,092

(22) Filed: Sep. 2, 2004

(30) Foreign Application Priority Data
Sep. 4, 2003 (JP) P2003-312987

(51) Int. Cl. B29C 35/08

(52) U.S. Cl. 428/542.8; 264/497; 425/174.4

(57) ABSTRACT

A three-dimensional laminated mold is formed by ejecting a mold material into a groove formed in a support. The support is formed from a support material ejected from an inkjet head. The support material has a ratio of density difference of equal to or less than 13.5%. The ratio of density difference is calculated from an equation:
ratio of density difference=((D1-D2)/D1)×100 wherein D1 indicates the density of the support material at 20° C., and D2 indicates the density of the support material at a temperature at which a viscosity of the support material measured using a rotational viscometer falls within the range of 10±1 mPa·s.

### BACKGROUND OF THE INVENTION

1. Field of the Invention

The present invention relates to a support material for three-dimensional laminating molding and an intermediate in the formation of a three-dimensional laminated mold using the support material, both suitable for an inkjet laminating molding device.

2. Related Art

A principle of a laminating molding is the same as that of a method for forming a three-dimensional contour map. That is, a three-dimensional object is sliced to produce sliced shapes, and then the sliced shapes are molded and laminated one on the other.

Examples of laminating molding methods include stereolithography using a photo-curing resin, powder lamination using metallic or resin powders, melt deposition in which resin is melted and deposited, and sheet lamination in which paper sheets, plastic sheets, or thin metal plates are laminated.

These laminating molding methods have spread rapidly along with a recent spread of a three-dimensional CAD and are also called rapid prototyping techniques. In these laminating molding methods, a three-dimensional object can be directly obtained from three-dimensional CAD data. The rapid prototyping technique is not only used in the field of trial manufacture, but also in the field of actual manufacture, since metallic molding has become possible.

Further, by using a three-dimensional printer, a digitizer, or a scanner as an output device of a three-dimensional CAD, the rapid prototyping technique has become used also as a three-dimensional copying machine. In particular, a laminating molding device using an ink-jet system is expected to be used in general-purpose three-dimensional printers or three-dimensional copying machines because the laminating molding device using an inkjet system has a simple configuration and is easy to handle compared with those using different system.

The laminating molding methods using an inkjet system are classified into a powder laminating method and a melt resin deposition method. The powder laminating method is developed by Massachusetts Institute of Technology. In the powder laminating method, binder is ejected into a powder layer of starch or plaster using an inkjet device, and then the ejected binder is cured. On the other hand, in the melt resin deposition method, resin is ejected to directly form a laminated shape without using any support layer.

The powder laminating method using powders requires a removal of unnecessary powders after molding and is not suited for an office environment because the powders scatter. Thus, the powder laminating method is less apt to a general-purpose three-dimensional printer or three-dimensional copying machine. On the other hand, the melt resin deposition method can be used in an office environment and is suited for the general-purpose three-dimensional printer or the three-dimensional copying machine.

The melt resin deposition method includes a method in which an arm of a robot attached with an ejection nozzle (the same as an inkjet head, in principle) is moved in three dimensions of XYZ and a method in which an inkjet head is placed in an X-Y plane and a Z direction.

However, because these methods do not use a support for supporting a mold during molding process, floating island shapes (shapes that suddenly appear in layers when laminating sliced data) or long beam shapes, such as a crossbar of a letter H, could not be formed by these methods. Therefore, moldable shapes are restricted, and so these methods are not suited for forming complex shapes, such as practical industrial products and medical models.

As a counter measure for those, Japanese Patent No. 3179547 proposes a method that uses a support. Specifically, support resin and mold resin are both laminated, and a surface is planarized if necessary. By this method, even complex shapes can be molded. The support can be formed such that a mold is buried within the support. Alternatively, a columnar or tabular support can be formed at necessary places. However, the former method is preferable from a view of enabling correspondence to any complex shape and not requiring special data processing. (The latter method requires data processing for providing the support.)

Materials used in such an inkjet-type laminating molding are classified into materials which are liquid at room temperature and materials which are solid at room temperature. There has been proposed to use photo-curing resin or thermosetting resin, which is liquid at room temperature, for the inkjet-type laminating molding.

However, if viscosity of the resin is high, then clogging occurs in nozzles, and on the contrary, if viscosity is low, then “dripping” occurs during photo-curing or thermosetting after lamination. Therefore, Japanese Patent No. 2697138 proposes to emit light in a flight path of the photo-curing resin droplets so as to irradiate the resin droplets in flight with the light. However, this method had a disadvantage that leakage light or reflected light irradiates an inkjet head, resulting in clogging of nozzles.

On the other hand, as a material which is solid at room temperature, resin which converts to liquid by heating, such as wax or hot melt resin, is often used. This type of material has a large advantage in that contamination is prevented during handling the material because the material is solid at room temperature and that clogging of a nozzle is prevented because ink evaporation at the time of melting can be minimized.

However, this type of material contains wax as a main component and has a large volume change involved in a phase change from a molten state to a solid state. Therefore, after the power to the device was turned OFF, the volume of ink inside the nozzle shrinks, thereby forming gaps in the solidified ink. When the ink is melted thereafter, the air intruded into the gaps become air bubbles in the ink, and the air bubbles clog the nozzle, thereby preventing ink ejection from the nozzles.

Japanese Patent-Application Publication No. HEI-09-123290 discloses an ink composition having a small volume change involved in a phase change. The ink composition having a small volume change has an advantage in that a highly accurate dimension is easily provided in lamination.

However, this ink composition was produced for printing, and thus, storage properties after printing were regarded as important. Also, the ink composition has a high melting point, considering its use in countries near the equator, leaving the ink composition in a vehicle during hot summer, or the like. Maintaining a high melting point leads to increase in ink ejection temperature and necessitates to maintain an inkjet head, an ink channel, and an ink tank at high temperatures. This in turn increases a start-up time of the device and electric power consumption during driving of the device.

Further, Japanese Patent Application-Publication No. HEI-7-70490 proposes a laminating molding method in which a mold is buried within a support and a material for a support (support material) with a different melting point from that of a material for a mold (mold material) is used. After a mold was formed, the support is removed using a difference in melting points. However, those materials are brittle, and the resultant mold easily breaks. In order to overcome this problem, Japanese Patent-Application Publication No. 2001-214098 proposes a mold material having ductility.

Further, a resin, which is solid at normal temperatures and converts to liquid when heated, warps due to shrinkage so that dimensional stability of the mold is impaired. In order to overcome this problems, Japanese Patent-Application Publication No. 2001-058357 discloses a laminating molding method of producing a mold while performing a smoothing process using a revolving or high-temperature roller, a rotary cutter, or the like. However, performing the smoothing process during lamination decreases time efficiency.

### SUMMARY OF THE INVENTION

In order to use an inkjet-type laminating molding device as a general-purpose and office-usable three-dimensional printer or three-dimensional copying machine, the device is desired to produce a mold that is hardly broken, to provide more highly precise and high speed molding, and to be lowly priced. However, inkjet-type laminating molding devices commercially available at present are not meeting those needs of users.

Further, a melting point and an ink ejection temperature must be high, and an inkjet head, an ink channel, and an ink tank must be maintained at high temperatures when a material which is solid at room temperature and converts to liquid when heated used as a support material, thereby increasing a start-up time of the device and electric power consumption when driving the device.

It is an object of the present invention to overcome the above problems, and to provide a support material for three-dimensional laminating molding and an intermediate in the formation of a three dimensional laminated mold, which enable a three-dimensional laminating molding device to form a highly precise mold having a complex three-dimensional structure at high speed with suppressed electric power consumption and to shorten a start-up time of the device.

It is also an object of the present invention to provide a laminating molding method and a laminating molding device for producing a highly-precise three-dimensional lamination mold having a complex three-dimensional structure at high speed with a short start-up time and less electric power consumption.

In order to attain the above and other objects, according to one aspect of the present invention, there is provided a support material for three-dimensional lamination molding in which a three-dimensional laminated mold that is made of a mold material ejected into a recess of a support that is formed by ejecting molten support material. The support material is solid at room temperature and has a ratio of density difference of equal to or less than 13.5%. The ratio of density difference is calculated from an equation:
ratio of density difference=((D1−D2)/D1)×100
wherein D1 indicates the density of the support material at 20° C., and
D2 indicates the density of the support material at a temperature at which a viscosity of the support material measured using a rotational viscometer falls within the range of 10±1 mPa·s.

According to a different aspect of the present invention, there is provided an intermediate in the formation of a three-dimensional laminated mold. The intermediate includes a support formed of a support material ejected from a first inkjet head and having grooves and a structure formed of a structure material ejected from a second inkjet head into the grooves of the support. The structure material is an active energy ray-curing compound. The support material is solid at room temperature and has a ratio of density difference of equal to or less than 13.5%. The ratio of density difference is calculated from an equation:
ratio of density difference=((D1−D2)/D1)×100
wherein D1 indicates the density of the support material at 20° C., and
D2 indicates the density of the support material at a temperature at which a viscosity of the support material measured using a rotational viscometer falls within the range of 10±1 mPa·s.

According to a different aspect of the present invention, there is provided a molding method for forming a three-dimensional laminated mold. The molding method includes the steps of ejecting a molten support material from a first inkjet head and solidifying the molten support material, thereby forming a first layer of a support having a first groove, ejecting a liquid structure material that is an active energy ray-curing compound from a second ink-jet head into the first groove, curing the liquid structure material by irradiating an active energy ray, thereby forming a first layer of a structure, ejecting the molten support material onto the first layer of the structure and solidifying the molten support material, thereby forming a second layer of the support having a second groove, ejecting the liquid structure material into the second groove, and curing the liquid structure material by irradiating the active energy ray, thereby forming a second layer of the structure. The support material is solid at room temperature and has a ratio of density difference of equal to or less than 13.5%. The ratio of density difference is calculated from an equation:
ratio of density difference=((D1−D2)/D1)×100
wherein D1 indicates the density of the support material at 20° C., and
D2 indicates the density of the support material at a temperature at which a viscosity of the support material measured using a rotational viscometer falls within the range of 10±1 mPa·s.

According to a different aspect of the preset invention, there is provided a molding device for producing a three-dimensional laminated mold. The molding device includes a first inkjet head, a second inkjet head, and a curing device. The first inkjet head ejects a molten support material. The molten support material solidifies to form a support having a groove. The second inkjet head ejects a liquid structure material into the groove formed in the support. The liquid structure material is an active energy curing compound. The curing device irradiates the liquid structure material by irradiating an active energy ray. The molten support material is one of material that melts by active energy ray irradiation and material that deforms by active energy ray irradiation. The first ink-jet head is located in the vicinity of the curing device.

### BRIEF DESCRIPTION OF THE DRAWINGS

In the drawings:

FIG. 1(a) is a schematic side view of a laminating molding device according to an embodiment of the present invention;

FIG. 1(b) is a schematic top view of the laminating molding device of FIG. 1(a);

FIG. 2 is a plan view of ejection heads of the laminating molding device of FIG. 1(a);

FIG. 3 is an exploded view of a linear head of the ejection heads of FIG. 2;

FIG. 4 is a cross-sectional view of the linear head;

FIG. 5 is a plan view of another example of ejection heads according to the embodiment of the present invention;

FIG. 6 is a schematic view of a laminating molding device according to a modification of the embodiment; and

FIG. 7 is a diagram showing results of evaluation on various physical properties and mold surface states of support material compositions in examples and comparative examples of the present invention.

### PREFERRED EMBODIMENT OF THE PRESENT INVENTION

An explanation will be provided for a three-dimensional laminating molding method according to a present embodiment.

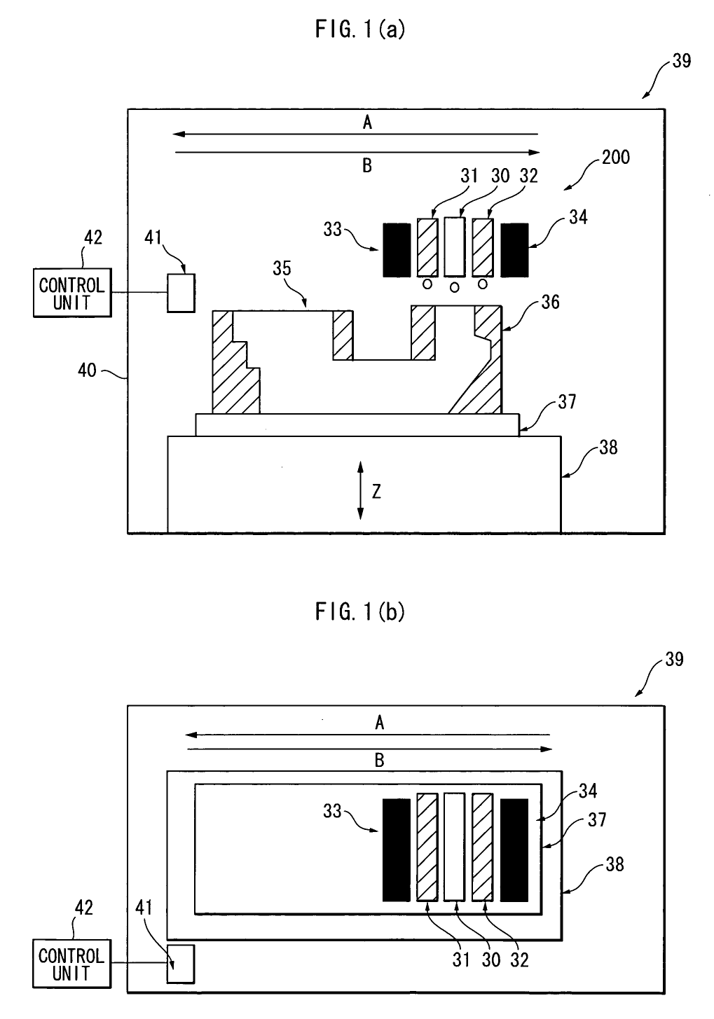

First, a surface data or a solid data of a three-dimensional shape, which has been designed using a three-dimensional CAD or scanned using a three-dimensional scanner or digitizer, is converted to an STL format and entered into a laminating molding device 39 shown in FIG. 1(a).

A molding direction of the three-dimensional shape to mold is determined based on the entered STL data. The molding direction is not particularly restricted, but generally, a direction in which a length of the object in a Z direction (height direction), i.e., a height, becomes the lowest is selected.

Then, project areas to an X-Y plane, an X-Z plane, and a Y-Z plane of the three-dimensional shape are determined. For a reinforcement of a block shape, each of the planes, other than the top surface of the X-Y plane, is shifted outward by an adequate amount. The shafting amount is not particularly restricted and differs depending on a shape, a size, and a material to use, but is generally about 1 to 10 mm. In this manner, a block shape confining a shape to mold (the top surface is open) is specified.

Next, the block shape is sliced in the Z direction into pieces with one-layer thickness. The one-layer thickness depends on a material to use, but is generally 20 to 60 μm. If there is only one object to mold, the block shape is placed at the center of a Z-stage 38 to be described later (a table which descends by one-layer distance each time one-layer molding completes). If there are two or more objects to mold, the corresponding block shapes can be placed on the Z-stage 38 or can be stacked one on the other. Preparation of those block shapes and slice data (contour data) and placing the block shapes on the Z-stage 38 can be automatically carried out when a material to use is specified.

Next, a laminating molding is performed using the molding device 39 shown in FIG. 1(a). That is, a support layer 36 is formed by ejecting a support material from ejection heads 31, 32, and simultaneously with this, a mold 35 is formed by ejecting a mold material from an ejection head 30 of the molding device 39. At this time, a position of ejecting the support material and a position of ejecting the mold material are controlled by an approximate determination (judging which of the support material and the mold material to eject to a position on a profile line) based on an outermost frame of the profile line of the slice data.

A configuration of the molding device 39 will be described. As shown in FIG. 1(a), the molding device 39 includes a molding unit 200, a support base 37, the Z-stage 38, and a casing 40. The molding unit 200, the support base 37, and the Z-stage 38 are all housed inside the casing 40.

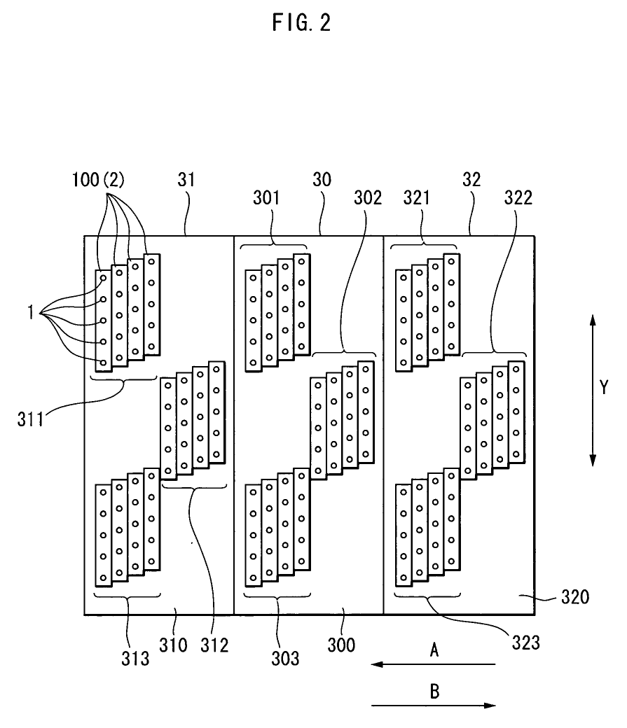

The molding unit 200 includes the ejection heads 30, 31, and 32, and curing devices 33 and 34. The ejection heads 30, 31, 32 have the same configuration, and each has a large number of linear heads 100 as shown in FIG. 2.

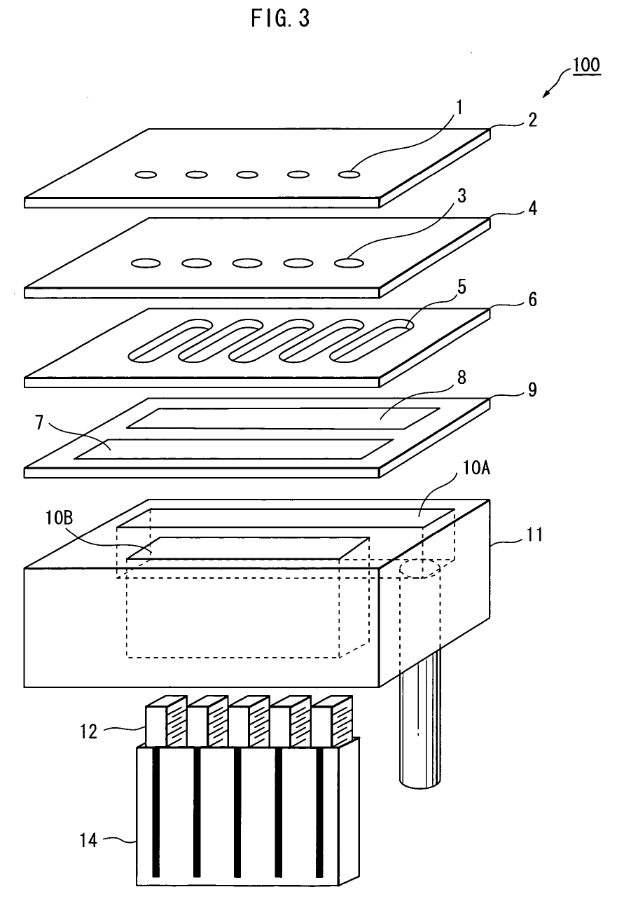

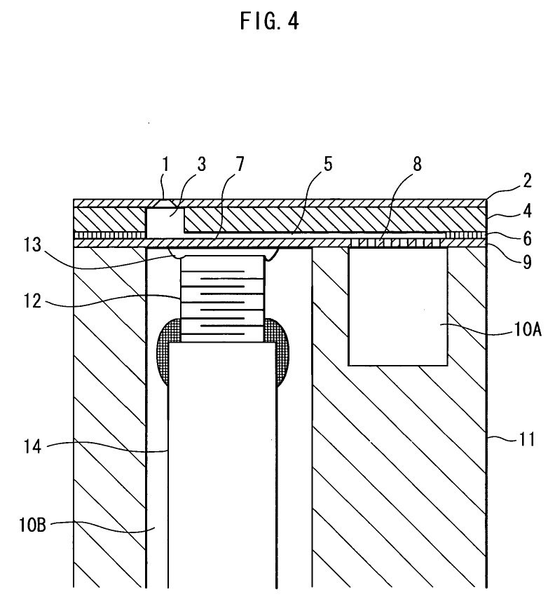

As shown in FIGS. 3 and 4, each linear head 100 includes a nozzle plate 2, a pressure-chamber plate 4, a restrictor plate 6, a diaphragm 7, a diaphragm plate 9, a base 11, piezoelectric elements 12, and a substrate 14. The nozzle plate 2 is formed with five nozzles 1 aligned in a line. The pressure-chamber plate 4 is formed with pressure chambers 3 for storing ejection material (support material or mold material). The restrictor plate 6 is formed with restrictors 5 for supplying the ejection material to the respective pressure chambers 3. The diaphragm 7 provides a part of a wall defining the pressure chambers 3. The diaphragm plate 9 is provided with a filter 8. The base 11 is formed with a supply channel 10A for supplying the ejection material to the restrictors 5 and an opening 10B for receiving the piezoelectric elements 12. The piezoelectric elements 12 are attached to the diaphragm 7 at one end by adhesive 13, which is silicon adhesive or the like, and fixed to the substrate 14 at another end.

The diaphragm plate 9, the restrictor plate 6, the pressure-chamber plate 4, and the base 11 are formed of stainless material or the like. The nozzle plate 2 is formed of nickel, and the substrate 14 is formed of insulating material, such as ceramics or polyimide.

The linear head 100 is assembled in the following manner. First, the base 11, the diaphragm plate 9, the restrictor plate 6, the pressure-chamber plate 4, and the nozzle plate 2 are positioned and fixed one on the other under the pressure. At this time, epoxy adhesive is used. Next, the piezoelectric elements 12 attached to the substrate 14 are inserted into the opening 10B of the base 11, and are attached to the diaphragm 7 using the adhesive 13. Then, the base 11 is attached to a main device by screw or the like. The linear heads 100 are not clogged with a squeeze out of epoxy adhesive and remain gastight.

With this configuration, ejection material stored in an ejection material tank (not shown) is supplied through the supply channel 10A, the filter 8, the restrictors 5, and the pressure chambers 3 into the nozzles 1. Through an application and disconnection of an electrical signal to the piezoelectric elements 12, the diaphragms 7 are deformed and restored, thereby ejecting ejection-material droplets from corresponding nozzles 1 and feeding the ejection material into the pressure chambers 3.

As shown in FIG. 2, the ejection head 30 includes a fixing plate 300 and multi-head units 301, 302, and 303. Each of the multi-head units 301, 302, 303 includes four linear heads 100 fixed to the fixing plate 300. The linear heads 100 of each multi-head units 301, 302, 303 are displaced stepwise in a Y direction by a predetermined amount equivalent to a pitch of a predetermined resolution. A nozzle pitch of the nozzles 1 in the Y direction of each linear head 100 is four times the pitch of the predetermined resolution. The multi-head units 301, 302, and 303 are arranged so that the nozzle pitch in the Y direction is maintained constant.

Here, the Y direction is perpendicular to both forward and reverse directions A and B in which the molding unit 200 moves. Both are actuated through uniaxial drive mechanism (not shown).

As mentioned above, the ejection heads 31 and 32 have the same configuration as the ejection head 30. That is, the ejection head 31 includes a fixing plate 310 and multi-head units 311, 312, and 313. Each of the multi-head units 311, 312, 313 includes four linear heads 100 fixed to the fixing plate 310. The linear heads 100 of each multi-head units 311, 312, 313 are displaced stepwise in the Y direction by the predetermined amount. The multi-head units 311, 312, and 313 are arranged so that the nozzle pitch in the Y direction is maintained constant. Similarly, the ejection head 32 includes a fixing plate 320 and multi-head units 321, 322, and 323. Each of the multi-head units 321, 322, 323 includes four linear heads 100 fixed to the fixing plate 320. The linear heads 100 of each multi-head units 321, 322, 323 are displaced stepwise in the Y direction by the predetermined amount. The multi-head units 321, 322, and 323 are arranged so that the nozzle pitch in the Y direction is maintained constant.

The fixing plates 300, 310, and 320 are fixed to one another by screws (not shown). The heights of nozzle arrangements with respect to a direction perpendicular to the directions A, B, and Y (i.e., in a direction Z shown in FIG. 1(a)) are the same among the multi-head units 301, 302, and 303, among the multi-head units 311, 312, and 313, and among the multi-head units 321, 322, and 323.

The ejection head 30 (multi-head units 301, 302, 303) ejects the mold material. The ejection head 31 (multi-head units 311, 312, and 313) and the ejection head 32 (multi-head units 321, 322 and 323) eject the support material. Materials that can be used as the support material and materials that can be used as the mold material will be described later.

Here, in order to overcome the brittleness of the mold, it is preferable to use a mold material having as high molecular weight as possible. However, there is a limitation in viscosity, and the viscosity at the time of ejection is desirably 30 mPa·s or less. Thus, a material having very high molecular weight cannot be used as the mold material. The sturdiness of the mold can be improved by using a low molecular weight material as the mold material and polymerizing to obtain a high molecular weight. In this case, it is preferable to use a material which is solid at room temperature for the support material and a material which is liquid at room temperature for the mold material. Setting an ejection temperature at room temperature or above is also effective means for broadening the selectivity of the materials.

The curing devices 33 and 34 are for curing the mold material and disposed to the left and right of the ejection heads 31 and 32, respectively. In this example, the curing devices 33 are ultraviolet-ray irradiation devices that irradiate ultraviolet rays for curing and polymerizing the photo-curing resin ink ejected from the ejection head 30.

In FIG. 1(a), the molding device 39 ejects the mold material from the ejection head 30 and the support material from the nozzle heads 31 and 32, and curs the mold material using the ultraviolet-ray irradiation devices 33 and 34.

More specifically, when the molding unit 200 moves in the direction A, ink which is solid at room temperature (solid ink) is ejected from the ejection head 31, and the photo-curing resin ink is ejected from the ejection head 30. Thus ejected photo-curing resin ink is cured by the ultraviolet-ray irradiation device 34. In this manner, one-layer of a support 36 and a mold 35 are formed on the mold support base 37. At this time, the nozzle head 32 and the ultraviolet-ray irradiation device 33 could supplementarily be used.

On the other hand, when the molding unit 200 moves in the direction B, the solid ink is ejected from the nozzle head 32, and the photo-curing resin ink is ejected from the ejection head 30. By using the ultraviolet-ray irradiation device 33, the ejected photo-curing resin ink is cured. In this manner, one-layer of the support 36 and the mold 35 are formed on the mold support base 37. At this time, the ejection head 31 and the ultraviolet-ray irradiation device 34 could supplementarily be used.

To maintain a predetermined distance of the molding unit 200 from the support 36 and the mold 35, the Z-stage 38 is lowered by a predetermined amount each time the one-layer of the support 36 and the mold 35 are formed in the above-described manner. It should be noted that ejection timings of the ink is controlled so that ink is ejected onto prescribed positions at a prescribed resolution.

By repeating the above operations, the support 36 is formed from the solid ink ejected from the ejection head 31 and 32. At the same time, the photo-curing resin ink is ejected from the ejection head 30 into a groove or a weir of the support 36 and polymerized and cured by the ultraviolet rays irradiated from the ultraviolet-ray irradiation devices 33 and 34, thereby producing the mold 35.

As described above, because the photo-curing resin ink is ejected in the groove or weir of the support 36, there is no danger of “dripping” of the mold material ink even if the mold material is liquid at room temperature. Therefore, a wide range of photo-curing resins and thermo-setting resins can be used as the mold material.

Further, because the ejection heads 31 and 32 are located at both sides of the ejection head 30, the photo-curing resin ink can be always ejected after the ejection of the solid ink both while the molding unit 200 is moving in the forward direction A and while the molding unit 200 is moving in the reverse direction B. Therefore, the support material and the mold material can be ejected both in the forward and reverse directions A and B, improving the laminating molding speed.

Further, because there are two ejection heads 31, 32 for the support material, even if one or more of the nozzles 1 is clogged in one of the ejection heads 31, 32, an alternative ejection is possible using corresponding one or more of the nozzles 1 in the another ejection head 31, 32, providing a control device for detecting the clogged nozzle 1 and performing necessary control operations is provided.

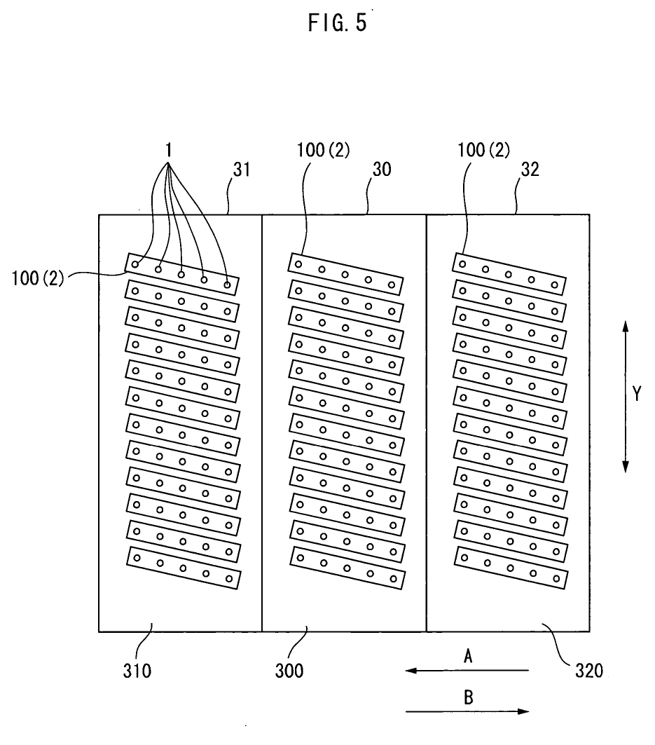

Although in the above-describe embodiment the ejection heads 30, 31, 32 each has the linear-head arrangement shown in FIG. 4, each ejection head 30, 31, 32 could have the linear-head arrangement shown in FIG. 5 instead.

That is, the plurality of linear heads 100 are fixed slant with respect to the directions A and B on each of the fixing plates 300, 301, and 302 so that the nozzle pitch with respect to the Y direction becomes a prescribed resolution.

With this linear-head arrangement, the mounting density of the linear heads 100 (nozzle plates 2) on the fixing plates 300, 310, and 320 can be increased, and at the same time, an ejection width in the Y direction can be increased. Therefore, a desired ejection width can be achieved using less nozzle plates 100.

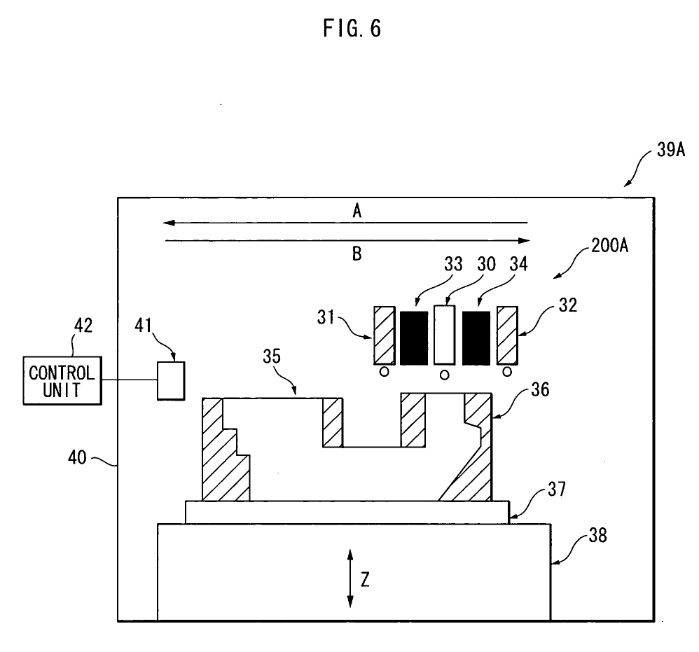

Next, a molding device 39A according to a modification of the embodiment will be described with reference to FIG. 6. The molding device 39A has the similar configuration as the above-described molding device 39 except in that the ultraviolet-ray irradiation devices 33 and 34 are disposed between the ejection heads 30 and 31 and between the ejection heads 30 and 32, respectively. In the molding device 39A, the ultraviolet-ray irradiation devices 33 and 34 are both used while a molting unit 200A moves in the forward direction A and also in the reverse direction B.

With this configuration, heat generated by the ultraviolet-rays irradiation device 33, 34 (active energy ray irradiation devices) when the ultraviolet-rays irradiation device 33, 34 irradiate the ultraviolet ray smoothes the surface of the laminated support material which has been ejected from the ejection head 31, 32, and as a result, dimensional stability of the mold 35 is enhanced. Because a sufficient dimensional stability of the mold 35 is secured without performing the smoothing process, time required for smoothing process can be omitted, enabling high speed laminating molding.

It should be noted that an ink recovering or recycle mechanism or the like can be provided to the molding device 39, 39A. A blade for removing an ink adhered to a nozzle surface or a detecting mechanism for detecting a defective nozzle may be provided as well. Also, it is preferable to control an inner temperature of the molding device 39, 39A during molding by a control unit 42 using a sensor 41.

That is, a three-dimensional laminated mold 35 is produced by: ejecting a molten support material from the inkjet head unit 31, 32 and solidifying the material, to thereby form a primary support layer having a reservoir portion; ejecting a liquid mold material composed of an active energy ray-curing compound into the reservoir portion of the primary support layer from the inkjet head unit 30 and irradiating the mold material with an active energy ray, to thereby form a primary mold layer; ejecting and solidifying a molten support material on the primary support layer, to thereby form a secondary support layer having a reservoir portion; and ejecting a liquid mold material composed of an active energy ray-curing compound into the reservoir portion of the secondary support layer and irradiating the mold material with an active energy ray, to thereby form a secondary mold layer laminated on the primary mold layer. In this manner, an intermediate in the formation of the three-dimensional laminating mold is formed in which the mold is buried in the support. Then, the intermediate is appropriately heated so as to remove the support through melting. As a result, the mold can be taken out of the intermediate.

Next, a specific support material will be described.

Conventionally, one or more components selected from the group consisting of fatty amide, polyester, polyvinyl acetate, a silicone resin, a coumarone resin, fatty ester, glyceride, wax, or the like are used for the support material.

Melting points of these support materials are relatively as high as about 80 to 90° C. Therefore, if these materials are used, the linear heads 100, ink channels, and the ink tank of the ejection heads 31, 32 for the support materials have to be stably maintained at high temperatures exceeding at least 100° C. through control of a heater or the like, thereby increasing a start-up time of the laminating molding device 39, 39A and requiring a large electric power consumption.

In this embodiment, it is preferable to use a support material that melts or deforms by active energy ray irradiation so that the irradiation of active energy ray during molding process smoothes the surface of a support. Also, it is preferable that the support material contain colorant for deep color, such as black dye or black pigment, that absorbs active energy ray. With this configuration, the support material more effectively absorbs the active energy ray, facilitating smoothness of each layer of the support.

The support material used in this embodiment is a material composition mixed with at least one kind selected from materials prescribed by the Law Concerning the Examination and Regulation of Manufacture, etc. of Chemical Substances (Japanese Chemical Substances Control Law, JCSCL) classified by MITI Nos. 8-358, 2-2489, 2-2492, and 9-1382. The materials mixed in an amount of preferably 50 wt % or more, more preferably 70 wt % or more, most preferably 90 wt % or more, provide a support material having a small volume change during phase change and low melting temperature and ejection temperature, and suppress the electric power consumption of the laminating molding device 39, 39A.

The following compounds are classified into the respective MITI numbers.
MITI No. 8-358: Hydrogenated palm oil fatty triglyceride, which is hydrogenated animal or vegetable oil or fat
MITI No. 2-2489: Stearyl stearate, cetyl palmitate, and hydrogenated jojoba oil, which are fatty (11 to 24 carbon atoms) alkyls (13 to 24 carbon atoms)
MITI No. 2-2492: Ethylene glycol distearate, which is ethylene glycol fatty (8 to 24 carbon atoms) diester
MITI No. 9-1382: Myristyl myristate

Specific examples of various materials include:
TRIFAT P-52 (available from Nikko Chemicals Co., Ltd.) and RIKEMAL VT (available from Riken Vitamin Co., Ltd.) as materials classified by MITI No. 8-358;
EXCEPARL SS (available from Kao Corporation), Crodamol CP (available from Croda Japan K.K.), EMALEX CC-18, EMALEX CC-16 (both available from Nihon-Emulsion Co., Ltd.), SS, N-SP, jojoba wax (all available from Nikko Chemicals Co., Ltd.), and RIKEMAL SL-800 (available from Riken Vitamin Co., Ltd.) as materials classified by MITI No. 2-2489;
EMANON 3201M (available from Kao Corporation), EMALEX EGS-C (available from Nihon-Emulsion Co., Ltd.), Cithrol EGDS3432 (available from Croda Japan K.K.), Genapol PMS (available from Clariant (Japan) K.K.), Estepearl 10 (available from Nikko Chemicals Co., Ltd.) as materials classified by MITI No. 2-2492;
EXCEPARL MY-M (available from Kao Corporation), Crodamol MM (available from Croda Japan K.K.), and MM (available from Nikko Chemicals Co., Ltd.) as materials classified by MITI No. 9-1382.

For further expressing functional properties, fatty amide, polyester, polyvinyl acetate, a silicone resin, a coumarone resin, fatty ester, glyceride, wax, or the like, various surface treatment agents, surfactants, viscosity modifiers, tackifier, antioxidants, age resistors, crosslinking promoters, ultraviolet absorbfers, plasticizers, preservatives, and dispersers may be mixed.

As a colorant, dyes and pigments which dissolve or stably disperse in the above support materials and excel in thermal stability are suitable. Solvent Dye is desirable but is not particularly limited. Further, two or more kinds of colorants can be mixed appropriately for color adjustment or the like.

A specific dye is described in the following.

[symbol] Black dye [symbol] MS BLACK VPC (Mitsui Toatsu Chemicals, Inc.), AIZEN SOT BLACK-1, AIZEN SOT BLACK-5 (Hodogaya Chemical Co., Ltd.), RESORIN BLACK GSN 200%, RESOLIN BLACK BS (Bayer Japan Ltd.), KAYASET BLACK A-N (Nippon Kayaku Co., Ltd.), DAIWA BLACK MSC (Daiwa Kasei Co., Ltd.), HSB-202 (Mitsubishi Chemical Corporation), NEPTUNE BLACK X60, NEOPEN BLACK X58 (BASF JAPAN LTD.), Oleosol Fast BLACK RL (Taoka Chemical Co., Ltd.), Chuo BLACK80, Chuo BLACK80-15 (Chuo Synthetic Chemical Co., Ltd.).

<Magenta dye> MS Magenta VP, MS Magenta HM-1450, MS Magenta Hso-147 (Mitsui Toatsu Chemicals, Inc.), AIZEN SOT Red-1, AIZEN SOT Red-2, AIZEN SOT Red-3, AIZEN SOT Pink-1, SPIRON Red GEHSPECIAL (Hodogaya Chemical Co., Ltd.), RESOLIN Red FB 200%, MACROLEX Red Violet R, MACROLEX ROT 5B (Bayer Japan Ltd.), KAYASET RedB, KAYASET Red 130, KAYASET Red 802(Nippon Kayaku Co., Ltd.), PHLOXIN, ROSE BENGAL, ACID Red (Daiwa Kasei Co., Ltd.), HSR-31, DIARESIN RedK (Mitsubishi Chemical Corporation), Oil Red (BASF JAPAN LTD.), Oil Pink330 (Chuo Synthetic Chemical Co., Ltd.).

[symbol] Cyan dye [symbol] MS Cyan HM-1238, MS Cyan HSo-16, Cyan Hso-144, MS Cyan VPG (Mitsui Toatsu Chemicals, Inc.), AIZEN SOT Blue-4(Hodogaya Chemical Co., Ltd.), RESOLIN BR.Blue BGLN 200%, MACROLEX Blue RR, CERES BlueGN, SIRIUS SUPRATURQ.Blue Z-BGL, SIRIUS SUPRA TURQ.Blue FB-LL330% (Bayer Japan Ltd.), KAYASET Blue Fr, KAYASET Blue N, KAYASET Blue 814, Turq.Blue GL-5 200, LightBlue BGL-5 200 (Nippon Kayaku Co., Ltd.), DAIWA Blue 7000, Oleosol Fast Blue GL (Daiwa Kasei Co., Ltd.), DIARESINBlue P (Mitsubishi Chemical Corporation), SUDAN Blue 670, NEOPEN Blue808, ZAPON Blue 806 (BASF JAPAN LTD.)

<Yellow dye> MS Yellow HSm-41, Yellow KX-7, Yellow EX-27 (Mitsui Toatsu Chemicals, Inc.), AIZENSOT Yellow-1, AIZEN SOT YelloW-3, AIZEN SOT Yellow-6 (Hodogaya Chemical Co., Ltd.), MACROLEX Yellow 6G, MACROLEX FLUOR, Yellow 10GN (Bayer Japan Ltd.), KAYASET Yellow SF-G, KAYASET Yellow2G, KAYASET Yellow A-G, KAYASET Yellow E-G (Nippon Kayaku Co., Ltd.), DAIWA Yellow 330HB (Daiwa Kasei Co., Ltd.), HSY-68 (Mitsubishi Chemical Corporation), SUDAN Yellow 146, NEOPEN Yellow 075 (BASF JAPAN LTD.), Oil Yellow 129 (Chuo Synthetic Chemical Co., Ltd.)

As a pigment, various organic or inorganic pigments can be used. Examples of pigments include: azo pigments such as azo lake, insoluble azo pigments, condensed azo pigment, and chelate azo pigments; and polycyclic pigments such as phthalocyanine pigments, perylene pigments, anthraquinone pigments, quinacridone pigments, dioxazine pigments, thioindigo pigments, isoindolinone pigments, and quinophthalone pigments. The pigments used are not particularly limited, and organic or inorganic pigments having the following color index numbers can be used according to the purpose, for example.

<Red or Magenta pigment> Pigment Red 3, 5, 19, 22, 31, 38, 43, 48:1, 48:2, 48:3, 48:4, 48:5, 49:1, 53:1, 57:1, 57:2, 58:4, 63:1, 81, 81:1, 81:2, 81:3, 81:4, 88, 104, 108, 112, 122, 123, 144, 146, 149, 166, 168, 169, 170, 177, 178, 179, 184, 185, 208, 216, 226, 257, Pigment Violet 3, 19, 23, 29, 30, 37, 50, 88, Pigment Orange 13, 16, 20, 36.

<Blue or Cyan pigment> pigment Blue 1, 15, 15:1, 15:2, 15:3, 15:4, 15:6, 16, 17-1, 22, 27, 28, 29, 36, 60.

<Green pigment> Pigment Green 7, 26, 36, 50.

<Yellow pigment> Pigment Yellow 1, 3, 12, 13, 14, 17, 34, 35, 37, 55, 74, 81, 83, 93, 94, 95, 97, 108, 109, 110, 137, 138, 139, 153, 154, 155, 157, 166, 167, 168, 180, 185, 193.

<Black pigment> Pigment Black 7, 28, 26.

Examples of specific trade names include Chromofine Yellow 2080, 5900, 5930, AF-1300, 2700L, Chromofine Orange 3700L, 6730, Chromofine Scarlet 6750, Chromofine Magenta 6880, 6886, 6891N, 6790, 6887, Chromofine Violet RE, Chromofine Red 6820, 6830, Chromofine Blue HS-3, 5187, 5108, 5197, 5085N, SR-5020, 5026, 5050, 4920, 4927, 4937, 4824, 4933GN-EP, 4940, 4973, 5205, 5208, 5214, 5221, 5000P, Chromofine Green 2GN, 2GO, 2G-550D, 5310, 5370, 6830, Chromofine Black A-1103, Seikafast Yellow 10 GH, A-3, 2035, 2054, 2200, 2270, 2300, 2400(B), 2500, 2600, ZAY-260, 2700(B), 2770, Seikafast Red 8040, C405(F), CA120, LR-116, 1531B, 8060R, 1547, ZAW-262, 1537B, GY, 4R-4016, 3820, 3891, ZA-215, Seikafast Carmine 6B1476T-7, 1483LT, 3840, 3870, Seikafast Bordeaux 10B-430, Seikalight Rose R40, Seikalight Violet B800, 7805, Seikafast Maroon 460N, Seikafast Orange 900, 2900, Seikalight Blue C718, A612, Cyanine Blue 4933M, 4933GN-EP, 4940, 4973 (Dainichiseika Color & Chemicals Mfg. Co., Ltd.), KET Yellow 401, 402, 403, 404, 405, 406, 416, 424, KET Orange 501, KET Red 301, 302, 303, 304, 305, 306, 307, 308, 309, 310, 336, 337, 338, 346, KET Blue 101, 102, 103, 104, 105, 106, 111, 118, 124, KET Green 201 (Dainippon Ink And Chemicals, Incorporated), Colortex Yellow 301, 314, 315, 316, P-624, 314, U10GN, U3GN, UNN, UA-414, U263, Finecol Yellow T-13, T-05, Pigment Yellow1705, Colortex Orange 202, Colortex Red101, 103, 115, 116, D3B, P-625, 102, H-1024, 105C, UFN, UCN, UBN, U3BN, URN, UGN, UG276, U456, U457, 105C, USN, Colortex Maroon601, Colortex BrownB610N, Colortex Violet600, Pigment Red 122, Colortex Blue516, 517, 518, 519, A818, P-908, 510, Colortex Green402, 403, Colortex Black 702, U905 (Sanyo Color Works, Ltd.), Lionol Yellow1405G, Lionol Blue FG7330, FG7350, FG7400G, FG7405G, ES, ESP-S (Toyo Ink MFG. Co., Ltd.), Toner Magenta E02, Permanent RubinF6B, Toner Yellow HG, Permanent Yellow GG-02, Hostapeam Blue B2G (available from Hoechst AG), carbon black #2600, #2400, #2350, #2200, #1000, #990, #980, #970, #960, #950, #850, MCF88, #750, #650, MA600, MA7, MA8, MA11, MA100, MA100R, MA77, #52, #50, #47, #45, #45 L, #40, #33, #32, #30, #25, #20, #10, #5, #44, CF9 (Mitsubishi Chemical Corporation).

The mold material is a material which cures by active energy ray irradiation, heating, or the like, for example, is an active energy ray-curing or thermosetting compound, and is preferably liquid at room temperature from the view of preventing nozzle clogging.

The active energy ray-curing compound is a compound which polymerizes through a radical polymerization or a cationic polymerization by irradiating the active energy ray. A compound containing an ethylene unsaturated group as the compound that polymerizes through radical polymerization, and a compound containing an aliphatic epoxy group or an oxetane ring as the compound that polymerizes through cationic polymerization are suitably used.

Examples of a photo-curing resin monomer in the mold material is preferably a resin monomer with relatively low viscosity which can polymerize radically and contains, in a molecular structure, an unsaturated double bond. Preferable examples thereof may include: a monofunctional group such as 2-ethylhexyl(meth)acrylate (EHA), 2-hydroxyethyl(meth)acrylate (HEA), 2-hydroxypropyl(meth)acrylate (HPA), caprolactone-modified tetrahydrofurfuryl(meth)acrylate, isobonyl(meth)acrylate, 3-methoxybutyl(meth)acrylate, tetrahydrofurfuryl(meth)acrylate, lauryl(meth)acrylate, 2-phenoxyethyl(meth)acrylate, isodecyl(meth)acrylate, isooctyl(meth)acrylate, tridecyl(meth)acrylate, caprolactone(meth)acrylate, and ethoxylated nonylphenol (meth)acrylate; a bifunctional group such as tripropylene glycol di(meth)acrylate, triethylene glycol di(meth)acrylate, tetraethylene glycol di(meth)acrylate, polypropylene glycol di(meth)acrylate, neopentyl glycol hydroxy pivalate ester di(meth)acrylate (MANDA), hydroxy pivalate neopentyl glycol ester di(meth)acrylate (HPNDA), 1,3-butanediol di(meth)acrylate (BGDA), 1,4-butanediol di(meth)acrylate (BUDA), 1, 6-hexanediol di(meth)acrylate (HDDA), 1,9-nonanediol di(meth)acrylate, diethylene glycol di(meth)acrylate (DEGDA), neopentyl glycol di(meth)acrylate (NPGDA), tripropylene glycol di(meth)acrylate (TPGDA), caprolactone-modified hydroxy pivalate neopentyl glycol ester di(meth)acrylate, propoxylated pentyl glycol di(meth)acrylate, ethoxy-modified bisphenol A di(meth)acrylate, polyethylene glycol 200 di(meth)acrylate, and polyethylene 400 di(meth)acrylate; and a polyfunctional group such as trimethylolpropane tri(meth)acrylate (TMPTA), pentaerythritol tri(meth)acrylate (PETA), dipentaerythritol hexa(meth)acrylate (DPHA), triallyl isocyanate, ε-caprolactone-modified dipentaerythritol (meth)acrylate, tris(2-hydroxyethyl)isocyanurate tri(meth)acrylate, ethoxylated trimethylol propane tri(meth)acrylate, propoxylated trimethylol propane tri(meth)acrylate, propoxylated glyceryl tri(meth)acrylate, pentaerythritol tetra(meth)acrylate, ditrimethylol propane tetra(meth)acrylate, dipentaerythritol hydroxypenta(meth)acrylate, ethoxylated pentaerythritol tetra(meth)acrylate, and penta(metha)acrylate ester.

Specific examples that can be used include KAYARAD TC-110S, KAYARAD R-128H, KAYARAD R-526, KAYARAD NPGDA, KAYARAD PEG400DA, KAYARAD MANDA, KAYARAD R-167, KAYARAD HX-220, KAYARAD HX-620, KAYARAD R-551, KAYARAD R-712, KAYARAD R-604, KAYARAD R-684, KAYARAD GPO, KAYARAD TMPTA, KAYARAD THE-330, KAYARAD TPA-320, KAYARAD TPA-330, KAYARAD PET-30, KAYARAD RP-1040, KAYARAD T-1420, KAYARAD DPHA, KAYARAD DPHA-2C, KAYARAD D-310, KAYARAD D-330, KAYARAD DPCA-20, KAYARAD DPCA-30, KAYARAD DPCA-60, KAYARAD DPCA-120, KAYARAD DN-0075, KAYARAD DN-2475, KAYAMER PM-2, KAYAMER PM-21, KS series HDDA, TPGDA, TMPTA, SR series 256, 257, 285, 335, 339A, 395, 440, 495, 504, 111, 212, 213, 230, 259, 268, 272, 344, 349, 601, 602, 610, 9003, 368, 415, 444, 454, 492, 499, 502, 9020, 9035, 295, 355, 399E494, 9041203, 208, 242, 313, 604, 205, 206, 209, 210, 214, 231E239, 248, 252, 297, 348, 365C, 480, 9036, 350 (Nippon Kayaku Co., Ltd.), BEAM SET 770 (Arakawa Chemical Industries, Ltd.).

As a photo-polymerizable prepolymer, a photo-polymerizable prepolymer used for production of ultraviolet light-curing resin can be used. Examples of the prepolymer that can be used without restriction may include a polyester resin, an acrylate resin, an epoxy resin, a urethane resin, an alkyd resin, an ether resin, and an acrylate or methacrylate of a polyvalent alcohol or the like.

Further, a water-soluble resin and an emulsion-type photo-curing resin can also be used. Specific examples thereof include polyester (meth)acrylate, bisphenol epoxy (meth)acrylate, bisphenol A epoxy (meth)acrylate, propylene oxide-modified bisphenol A epoxy (meth)acrylate, alkali-soluble epoxy (meth)acrylate, acrylate-modified epoxy (meth)acrylate, phosphate-modified epoxy (meth)acrylate, polycarbonate urethane (meth)acrylate, polyester urethane (meth)acrylate, cycloaliphatic urethane (meth)acrylate, aliphatic urethane (meth)acrylate, polybutadiene (meth)acrylate, and polystyryl (meth)acrylate.

Examples include: Diabeam UK6105, Diabeam UK6038, Diabeam UK6055, Diabeam UK6063, Diabeam UK4203 (Mitsubishi Rayon Co., Ltd.), Olestar Ral574 (Mitsui Chemicals, Inc.), KAYARAD UX series 2201, 2301, 3204, 3301, 4101, 6101, 7101, 8101, KAYARAD R&EX series, 011, 300, 130, 190, 2320, 205, 131, 146, 280, KAYARAD MAX series, 1100, 2100, 2101, 2102, 2203, 2104, 3100, 3101, 3510, 3661 (Nippon Kayaku Co., Ltd.), BEAM SET 700, 710, 720, 750, 502H, 504H, 505A-6, 510, 550B, 551B, 575, 261, 265, 267, 259, 255, 271, 243, 101, 102, 115, 207TS, 575CB, AQ-7, AQ-9, AQ-11, EM-90, EM-92 (Arakawa Chemical Industries, Ltd.), 0304TB, 0401TA, 0403KA, 0404EA, 0404TB, 0502TI0502TC, 102A, 103A, 103B, 104A, 1312MA, 1403EA, 1422TM, 1428TA, 1438MG, 1551 MB, IBR-305, 1FC-507, 1SM-012, 1AN-202, 1ST-307, 1AP-201, 1PA-202, 1XV-003, 1 KW-430, 1 KW-501, 4501TA, 4502MA, 4503MX, 4517 MB, 4512MA, 4523TI, 4537MA, 4557 MB, 6501MA, 6508MG, 6513MG, 6416MA, 6421MA, 6560MA, 6614MA, 717-1, 856-5, QT701-45, 6522MA, 6479MA, 6519 MB, 6535MA, 724-65A, 824-65, 6540MA, 6R 1-350, 6TH-419, 6HB-601, 6543 MB, 6AZ-162, 6AZ-309, 6AZ-215, 6544MA, 6AT-203B, 6BF-203, 6AT-113, 6HY316, 6RL-505, 7408MA, 7501TE, 7511MA, 7505TC, 7529MA, MT408-13, MT408-15, MT408-42, 7CJ-601, 7PN-302, 7541 MB, 7RZ-011, 7613MA, 8DL-100, 8AZ-103, 5YD-420, 9504MNS, Acryt WEM-202U, 030U, 321U, 306U, 162, WBR-183U, 601U, 401U, 3DR-057, 829, 828 (TAISEI CHEMICAL INDUSTRIES, LTD.), and the like.

Further, as a photo-polymerization initiator, an arbitrary substance which forms radicals through emission of light (in particular, ultraviolet light of wavelength 220 nm to 400 nm) can be used.

Specific examples thereof include acetophenone, 2,2-diethoxy acetophenone, p-dimethylamino acetophenone, benzophenone, 2-chlorobenzophenone, p,p'-dichloro benzophenone, p,p-bisdiethylamino benzophenone, Michler's ketone, benzyl, benzoin, benzoin methyl ether, benzoin ethyl ether, benzoin isopropyl ether, benzoin-n-propyl ether, benzoin isobutyl ether, benzoin-n-butyl ether, benzyl methyl ketal, thioxanthone, 2-chloro thioxanthone, 2-hydroxy-2-methyl-1-phenyl-1-one, 1-(4-isopropylphenyl)2-hydroxy-2-methylpropane-1-one, methyl benzoyl formate, 1-hydroxycyclohexyl phenyl ketone, azobisisobutyronitrile, benzoyl peroxide, and di-tert-butylperoxide. One kind of those photo-polymerization initiators can be used alone, or several kinds thereof can be used in combination.

A sensitizer can also be used for preventing a decrease of curing speed during photoirradiation (in particular, ultraviolet light) caused by pigment in ink absorbing or shielding a light (in particular, ultraviolet light).

Examples of the sensitizer include: an aliphatic amine; a cyclic amine compound, such as an amine containing an aromatic group or piperidine; a urea compound, such as o-tolyl thiourea; a sulfur compound, such as sodium diethyl thiophosphate or soluble salt of an aromatic sulfinic acid; a nitrile compound, such as N,N′-disubstituted-p-amino benzonitrile; a phosphorus compound, such as tri-n-butyl phosphine or sodium diethyl dithiophosphide; Michler's ketone; an N-nitroso hydroxylamine derivative; an oxazolidine compound; a tetrahydro-1,3-oxazine compound; and a nitrogen compound, such as a condensate of formaldehyde or acetaldehyde with an diamine. One kind of those sensitizers can be used alone, or several kinds thereof can be used in combination.

As the colorant, dyes and pigments which dissolve or stably disperse in the above mold material are suitable. The above-mentioned colorant used for the support material can be used therefor, but is not particularly limited. Further, two or more kinds of colorants can be mixed appropriately for color adjustment or the like.

In the present embodiment, it is preferable that the support material and the mold material have different color such that a resultant support has different color from a mold. This makes easier to remove the support from the mold. It is also preferable that the mold material contain a low-boiling point organic solvent (in particular, low-boiling point alcohol) so as to increase the drying speed.

Examples of the low-boiling point alcohol include an aliphatic alcohol having 1 to 4 carbon atoms, such as methyl alcohol, ethyl alcohol, n-propyl alcohol, isopropyl alcohol, n-butyl alcohol, sec-butyl alcohol, tert-butyl alcohol, and isobutyl alcohol. One kind of those low-boiling point alcohols can be used alone, or several kinds thereof can be used in combination.

A content of the low-boiling point solvent is preferably 1 to 30 wt %, more preferably 10 to 20 wt % with respect to the total weight of the ink composition. If the content exceeds 30 wt %, a problem in discharging property may occur, and if the content is less than 1 wt %, the drying speed may not increase.

A mechanism for curing the mold material could be an ultraviolet radiation lamp, an electron irradiation device, or the like. A mechanism to remove ozone is preferably provided.

Examples of the lamp include a high-pressure mercury-vapor lamp, an ultra-high pressure mercury lamp, and metal halide. Although the ultra-high pressure mercury lamp is a point light source, a Deep UV type, whose light utilization efficiency has been improved by combining with an optical system, can irradiate light in a short wavelength region. The metal halide is effective for colored object because the metal halide emits light in a broad wavelength range. Halide of metal, such as Pb, Sn, or Fe, is used and can be selected according to an absorption spectrum of a photo initiator. A lamp effective for curing can be used without particular restriction. For example, commercially available lamps such as H lamp, D lamp, or V lamp (available from Fusion UV Systems, Inc.) can be used.

Following experiments have been conducted using the molding device 39A shown in FIG. 6.

Experiment 1

A total of 300 g containing 10 parts by weight of urethane acrylate (trade name: DIABEAM UK6038, available from Mitsubishi Rayon Co., Ltd.) and 90 parts by weight of neopentyl glycol hydroxypivalate ester di(meth)acrylate (trade name: KAYARAD MANDA, available from Nippon Kayaku Co., Ltd.) as a mold material, 3 parts by weight of a photo-polymerization initiator (trade name: IRGACURE 1700, available from Ciba Specialty Chemicals), and 2 parts by weight of a blue pigment (trade name: Lionel Blue 7400G, available from TOYO INK MFG. CO., LTD.) as a colorant was dispersed until a uniform mixture was obtained using a homogenizer (trade name: HG30, manufactured by Hitachi Koki Co., Ltd.) at a stirring speed of 2,000 rpm. Successively, the resultant mixture was passed through a filter to remove impurities or the like, thereby obtaining a uniform ink composition for a mold (mold material).

A total of 300 g containing 100 parts by weight of hydrogenated palm oil fatty triglyceride which is hydrogenated animal or vegetable oil or fat, TRIFAT P-52 (MITI No. 8-358, available from Nikko Chemicals Co., Ltd.) as a support material and 3 parts by weight of a black pigment (MA77, available from Mitsubishi Chemical Corporation) as a colorant was dispersed until a uniform mixture was obtained using a homogenizer (HG30, manufactured by Hitachi Koki Co., Ltd.) at a stirring speed of 2,000 rpm. Successively, filtration was carried out to remove impurities or the like, to thereby obtain a uniform ink composition for a support (support material).

The melting point was measured using a micro melting point apparatus MP-S3 (manufactured by Yanagimoto Manufacturing Co.). About 3 mg of the ink was placed on a sample holder and was heated at a temperature increase rate of about 2° C./min. A range from a temperature at which the ink begins to melt to a temperature at which the ink completes the melting is defined as a melting point. The melting point of the support material measured in this method ranged from 52 to 55° C.

Next, a method for measuring densities of ink composition for a support (support material) at a ejection temperature (temperature of molten ink) and a room temperature will be described. It should be note that in this and following experiments, the ejection temperature is a temperature at which a viscosity of the ink composition measured using a rotational viscometer (ELD model, manufactured by TOKIMEC Inc.) falls within the range of 10±1 mPa·s.

The density at the ejection temperature is measured by: using a specific gravity bottle (Hubbard, available from Sibata Scientific Technology Ltd.); maintaining the temperature of an ink composition at a constant temperature in a temperature controlled bath; and measuring the weight of the ink composition in a molten state. The density at room temperature is measured by: pouring molten ink composition into a cylindrical metal mold; solidifying the ink composition through natural cooling; leaving the ink composition to stand at room temperature for 30 minutes; and forming an ink pellet within a range of 12±1 mm in ink height and 13.5±0.5 mm in diameter using sand paper (P600, available from KOVAX Corporation). The dimensions and weight of the pellet were measured, to thereby determine the density.

Further, a ratio of a difference between the density at the ejection temperature and the density at 20° C. (hereinafter, abbreviated as “density ratio”) was determined through the following equation.
density ratio=((D1−D2)/D1)×100
wherein D1 is density of ink composition at 20° C.; and
D2 is density of ink composition at the ejection temperature.

In this experiment, the support material (ink component for a support) has a density of 960.1 kg/m³ at 20° C., a density of 857.9 kg/m³ at the ejection temperature, and thus, a density ratio of 10.6%.

Using thus obtained mold material and support material, a mold was formed while curing the mold material by irradiating the mold material with 350 mJ/cm2 of light using the ultraviolet-ray irradiation devices 33 and 34 (SPOT CURE SP5-250DB, manufactured by Ushio Inc.). The mold material and the support material were ejected at the ejection temperature of 90° C. Inkjet heads (GEN3E1, manufactured by Hitachi Printing Solutions, Ltd.) were used as the ejection heads 30, 31, and 32.

In this experiment, the support material and the mold material are colored black and blue, respectively.

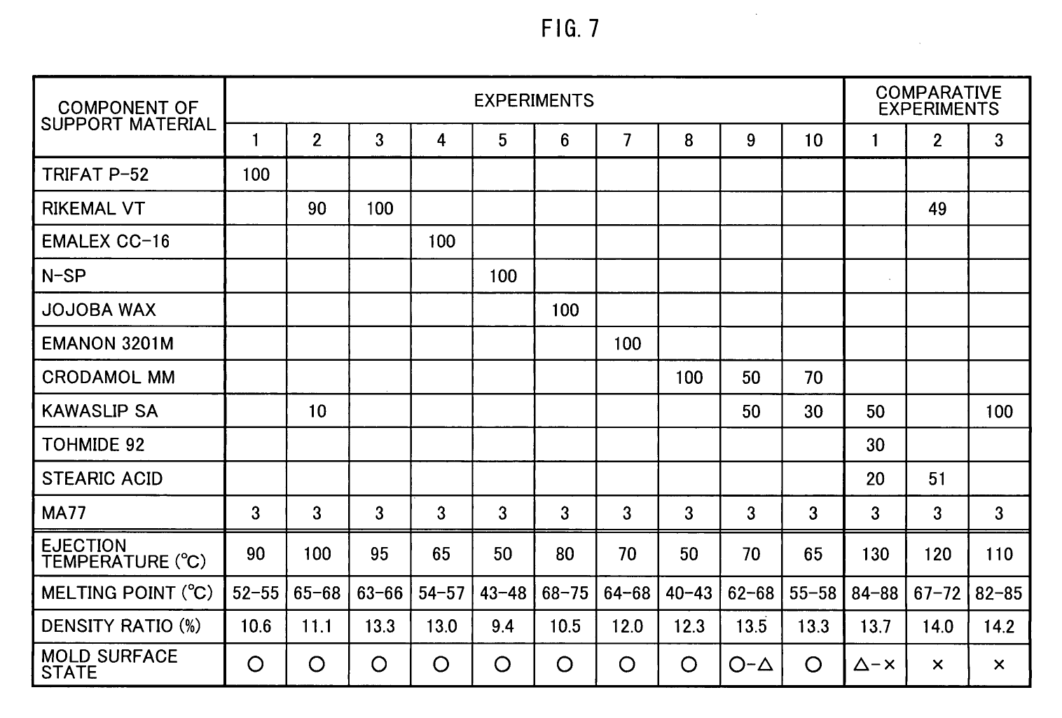

The formed mold had no warp or partial deformation, and had a smooth surface. FIG. 7 shows the results of the evaluation. In FIG. 7, ◯ represents a mold having a smooth surface without warp or partial deformation, X represents a mold with warp or partial deformation, and Δ represents a mold having a surface state between these states represented by ◯ and X.

Second Experiment

A total of 300 g containing 90 parts by weight of hydrogenated palm oil fatty triglyceride which is hydrogenated animal or vegetable oil or fat, RIKEMAL VT (MITI No. 8-358, available from Riken Vitamin Co., Ltd.) and 10 parts by weight of Kawaslip SA (available from Kawaken Fine Chemicals Co., Ltd.), both as support materials, and 3 parts by weight of a black pigment (MA77) was dispersed in the same manner as in the first experiment until a homogeneous mixture was obtained using a homogenizer (HG30, manufactured by Hitachi Koki Co., Ltd.) at a stirring speed of 2,000 rpm. Successively, filtration was carried out to remove impurities or the like, to thereby obtain a homogeneous ink composition for a support (support material). The composition had a melting point of 65 to 68° C. The support material in the second experiment had a density of 961.5 kg/m³ at 20° C., a density of 854.3 kg/m³ at the ejection temperature, and thus, a density ratio of 11.1%.

Mold formation was carried out by: using the same mold material as that in the first experiment and the molding device 39A shown in FIG. 6; and curing the mold material through irradiation using an ultraviolet irradiation device (SPOT CURE SP5-250DB, manufactured by Ushio Inc.) with an amount of light of 350 mJ/cm². The mold material and the support material were ejected at an ejection temperature of 100° C. Inkjet heads (GEN3E1, manufactured by Hitachi Printing Solutions, Ltd.) were used as the ejection heads 30, 31, and 32.

As shown in FIG. 7, a resultant mold had no warp or partial deformation and had a smooth surface.

Third to Eighth Experiments

A total of 300 g containing 100 parts by weight of support material and 3 parts by weight of a black pigment (MA77) was dispersed in the same manner as in the first experiment until a uniform mixture was obtained using a homogenizer (HG30, manufactured by Hitachi Koki Co., Ltd.) at a stirring speed of 2,000 rpm. Successively, filtration was carried out to remove impurities or the like, to thereby obtain a uniform ink composition for a support (support material).

In the third to eight experiments, the followings were used as the support material which was mixed with the black pigment (MA77):
hydrogenated palm oil fatty triglyceride which is hydrogenated animal or vegetable oil or fat, RIKEMAL VT (MITI No. 8-358, available from Riken Vitamin Co., Ltd.) in the third experiment;
MALEX CC-16 (MITI No. 2-2489, available from Nihon-Emulsion Co., Ltd.) in the fourth experiment;
N-SP (MITI No. 2-2489, available from Nikko Chemicals Co., Ltd.) in the fifth experiment;
jojoba wax (MITI No. 2-2489, available from Nikko Chemicals Co., Ltd.) in the sixth experiment;
ethylene glycol distearate which is ethylene glycol fatty (8 to 24 carbon atoms) diester, EMANON 3201M (MITI No. 2-2492, available from Kao Corporation) in the seventh experiment; and
myristyl myristate, Crodamol MM (MITI No. 9-1382, available from Croda Japan K.K.) in the eighth experiment.

Mold formation was carried out by: using a mold material that is the same as that in the first experiment and the molding device 39A shown in FIG. 6; and curing the mold material through irradiation using an ultraviolet irradiation device (SPOT CURE SP5-250 DB, manufactured by Ushio Inc.) with an amount of light of 350 mJ/cm². The mold material and the support material were ejected at an ejection temperature of 50-95° C. Inkjet heads (GEN3E1, manufactured by Hitachi Printing Solutions, Ltd.) were used as the ejection heads 30, 31, and 32.

As shown in FIG. 7, molds formed in the third to eighth experiments had no warp or partial deformation, and had a smooth surface.

FIG. 7 shows the ejection temperature, melting point, and density ratio of the support materials, and the results of evaluation on surface state of the molds in the third to eighth examples.

Ninth Experiment

A total of 300 g containing 50 parts by weight of myristyl myristate, Crodamol MM (MITI No. 9-1382, available from Croda Japan K.K.) and 50 parts by weight of Kawaslip SA (available from Kawaken Fine Chemicals Co., Ltd.), both as support materials, and 3 parts by weight of a black pigment (MA77) as a colorant was dispersed in the same manner as in the first experiment until a uniform mixture was obtained using a homogenizer (HG30, manufactured by Hitachi Koki Co., Ltd.) at a stirring speed of 2,000 rpm. Successively, filtration was carried out to remove impurities or the like, to thereby obtain a uniform ink composition for a support (support material.

The support material had a melting point of 62 to 68° C. and a density ratio of 13.5%.

Mold formation was carried out by: using the same mold material as that in the first experiment and the molding device 39A shown in FIG. 6; and curing the mold material through irradiation using an ultraviolet irradiation device (SPOT CURE SP5-250DB, manufactured by Ushio Inc.) with an amount of light of 350 mJ/cm². The mold material and the support material were ejected at an ejection temperature of 70° C. Inkjet heads (GEN3E1, manufactured by Hitachi Printing Solutions, Ltd.) were used as the ejection heads 30, 31, and 32.

A resultant mold had no warp or partial deformation but had a surface slightly lacking smoothness at a level not causing problems.

Experiment 10

A total of 300 g containing 70 parts by weight of myristyl myristate, Crodamol MM (MITI No. 9-1382, available from Croda Japan K.K.) and 30 parts by weight of Kawaslip SA (available from Kawaken Fine Chemicals Co., Ltd.), both as support materials, and 3 parts by weight of a black pigment (MA77) as a colorant was dispersed in the same manner as in the first experiment until a uniform mixture was obtained using a homogenizer (HG30, manufactured by Hitachi Koki Co., Ltd.) at a stirring speed of 2,000 rpm. Successively, filtration was carried out to remove impurities or the like, to thereby obtain a uniform ink composition for a support (support material). The support material had a melting point of 55 to 58° C. and a density ratio of 13.3%.

Mold formation was carried out by: using the same mold material as that in the first experiment and the molding device 39A shown in FIG. 6; and curing the mold material through irradiation using an ultraviolet irradiation device (SPOT CURE SP5-250DB, manufactured by Ushio Inc.) with an amount of light of 350 mJ/cm². The mold material and the support material were ejected at an ejection temperature of 65° C. Inkjet heads (GEN3E1, manufactured by Hitachi Printing Solutions, Ltd.) were used as the ejection heads 30, 31, and 32.

As shown in FIG. 7, a resultant mold had no warp or partial deformation, and had a smooth surface.

First Comparative Experiment

A total of 300 g containing 50 parts by weight of Kawaslip SA, 30 parts by weight of TOHMIDE 92 (available from FUJI KASEI KOGYO CO., LTD.), and 20 parts by weight of stearic acid (available from Wako Pure Chemical Industries, Ltd.), all as support materials, and 3 parts by weight of a black pigment (MA77) as a colorant was dispersed in the same manner as in the first experiment until a uniform mixture was obtained using a homogenizer (HG30, manufactured by Hitachi Koki Co., Ltd.) at a stirring speed of 2,000 rpm. Successively, filtration was carried out to remove impurities or the like, to thereby obtain a uniform ink composition for a support (support material). The support material had a melting point of 84 to 88° C. and a density ratio of 13.7%.

Mold formation was carried out by: using the same mold material as that in the first experiment and the molding device 39A shown in FIG. 6; and curing the mold material through irradiation using an ultraviolet irradiation device (SPOT CURE SP5-250DB, manufactured by Ushio Inc.) with an amount of light of 300 mJ/cm2. The mold material and the support material were ejected at an ejection temperature of 130° C. Inkjet heads (GEN3E1, manufactured by Hitachi Printing Solutions, Ltd.) were used as the ejection heads 30, 31, and 32.

A formed mold had slight deformation or dimensional distortion in an end portion and an elongated portion. Further, the surface was not very smooth. FIG. 7 shows the results of the evaluation.

Second Comparative Experiment

A total of 300 g containing 49 parts by weight of RIKEMAL VT (available from Riken Vitamin Co., Ltd.) and 51 parts by weight of stearic acid, both as support materials, and 3 parts by weight of a black pigment (MA77) as a colorant was dispersed in the same manner as in the first experiment until a uniform mixture was obtained using a homogenizer (HG30, manufactured by Hitachi Koki Co., Ltd.) at a stirring speed of 2,000 rpm. Successively, filtration was carried out to remove impurities or the like, to thereby obtain a uniform ink composition for a support (support material). The support material had a melting point of 67 to 72° C. and a density ratio of 14.0%.

Mold formation was carried out by: using the same mold material as that in the first experiment and the molding device 39A shown in FIG. 6; and curing the mold material through irradiation using an ultraviolet irradiation device (SPOT CURE SP5-250DB, manufactured by Ushio Inc.) with an amount of light of 300 mJ/cm². The mold material and the support material were ejected at an ejection temperature of 120° C. Inkjet heads (GEN3E1, manufactured by Hitachi Printing Solutions, Ltd.) were used as the ejection heads 30, 31, and 32.

A formed mold had slight deformation or dimensional distortion in an end portion and an elongated portion. Further, the surface was not smooth. FIG. 7 shows the results of the evaluation.

Third Comparative Experiment

A total of 300 g containing 100 parts by weight of Kawaslip SA as support material and 3 parts by weight of a black pigment (MA77) as a colorant was dispersed in the same manner as in the first experiment until a uniform mixture was obtained using a homogenizer (HG30, manufactured by Hitachi Koki Co., Ltd.) at a stirring speed of 2,000 rpm. Successively, filtration was carried out to remove impurities or the like, to thereby obtain a uniform ink composition for a support (support material). The support material had a melting point of 82 to 85° C. and a density ratio of 14.2%.

Mold formation was carried out by: using the same mold material as that in the first experiment and the molding device 39A shown in FIG. 6; and curing the mold material through irradiation using an ultraviolet irradiation device (SPOT CURE SP5-250 DB, manufactured by Ushio Inc.) with an amount of light of 300 mJ/cm². The mold material and the support material were ejected at an ejection temperature of 110° C. Inkjet heads (GEN3E1, manufactured by Hitachi Printing Solutions, Ltd.) were used as the ejection heads 30, 31, and 32.

Thus formed mold had slight deformation or dimensional distortion in an end portion and an elongated portion. Further, the surface state was not smooth. FIG. 7 shows the results of the evaluation.

As will be understood from FIG. 7, the ejection temperatures of the support materials in the above-described experiments range from 50 to 100° C., which is much lower than the range of 110 to 130° C. in the comparative experiments. Further, most of the melting points in the experiments range from 40 to 68° C. (except the sixth experiments), which is lower than the range of 67 to 88° C. in the comparative experiments. The density ratios in the experiments range from 9.4 to 13.5%, which is lower than the range of 13.7 to 14.2% in the comparative experiments. The molds that were formed using the support materials having the density ratios of 9.4 to 13.3% have no warp or partial deformation and have smooth surface. The support material used in the sixth experiment has a melting point of 68 to 75° C., which is slightly higher than those in the other experiment, but has a low density ratio of 10.5%. Thus, the mold formed in the sixth experiment has a smooth surface, which is evaluated as a satisfactory surface state (◯).

As described above, it is preferable to use a support material that is solid at room temperature and has a ratio of density difference of equal to or less than 13.5%. The ratio of density difference being calculated from an equation:
ratio of density difference=((D1−D2)/D1)×100
wherein D1 indicates the density of the support material at 20° C., and
D2 indicates the density of the support material at a melting temperature at which a viscosity of the support material measured using a rotational viscometer falls within the range of 10±1 mPa·s.

With this configuration, a support material for three-dimensional lamination molding, an intermediate in the formation of a three-dimensional laminated mold, a molding method for producing a three-dimensional laminated mold, and a molding device for producing a three-dimensional laminated mold capable of highly precise and high speed molding of a mold having a complex, three-dimensional structure, with suppressed electric power consumption during start-up can be provided.

While some exemplary embodiments of this invention have been described in detail, those skilled in the art will recognize that there are many possible modifications and variations which may be made in these exemplary embodiments while yet retaining many of the novel features and advantages of the invention.

1. A support material for three-dimensional lamination molding in which a three-dimensional laminated mold is made of a mold material ejected into a recess of a support that is formed by ejecting molten support material, the support material being solid at room temperature and having a ratio of density difference of equal to or less than 13.5%, the ratio of density difference being calculated from an equation:
ratio of density difference=((D1−D2)/D1)×100
wherein D1 indicates the density of the support material at 20° C., and
D2 indicates the density of the support material at a temperature at which a viscosity of the support material measured using a rotational viscometer falls within the range of 10±1 mPa·s.

2. The support material according to claim 1, wherein the ratio of density difference of the support material is in the range from 9.4 to 13.5%.

3. The support material according to claim 1, wherein the temperature at which the viscosity of the support material measured using the rotational viscometer falls within the range of 10±1 mPa·s is 100° C. or less.

4. The support material according to claim 1, wherein the support material is one of material that melts by active energy ray irradiation and material that deforms by active energy ray irradiation.

5. The support material according to claim 4, wherein the support material contains colorant that absorbs the active energy ray.

6. The support material according to claim 1, wherein a main component of the support material is one of organic compounds selected from groups of:
hydrogenated palm oil fatty triglyceride, which is hydrogenated animal or vegetable oil or fat,
stearyl stearate, cetyl palmitate, and hydrogenated jojoba oil, which are fatty alkyls,
ethylene glycol distearate, which is ethylene glycol fatty diester, and
myristyl myristate.

7. An intermediate in the formation of a three-dimensional laminated mold, the intermediate comprising:
a support formed of a support material ejected from a first inkjet head, the support having grooves; and
a structure formed of a structure material ejected from a second inkjet head into the grooves of the support, wherein:
the support material is solid at room temperature and has a ratio of density difference of equal to or less than 13.5%;
the ratio of density difference is calculated from an equation:
ratio of density difference=((D1−D2)/D1)×100
wherein D1 indicates the density of the support material at 20° C., and
D2 indicates the density of the support material at a temperature at which a viscosity of the support material measured using a rotational viscometer falls within the range of 10±1 mPa·s, and
the structure material is an active energy ray-curing compound.

8. The intermediate according to claim 7, wherein the ratio of density difference of the support material is in the range from 9.4 to 13.5%.

9. The intermediate according to claim 7, wherein the temperature at which the viscosity of the support material measured using the rotational viscometer falls within the range of 10±1 mPa·s is 100° C. or less.

10. The intermediate according to claim 7, wherein the support material is one of material that melts by active energy ray irradiation and material that deforms by active energy ray irradiation.

11. The intermediate according to claim 7, wherein the support material contains colorant that absorbs the active energy ray.

12. The intermediate according to claim 8, wherein the support has different color from the structure.

13. The intermediate according to claim 7, wherein a main component of the support material is one of organic compounds selected from groups of:
hydrogenated palm oil fatty triglyceride, which is hydrogenated animal or vegetable oil or fat,
stearyl stearate, cetyl palmitate, and hydrogenated jojoba oil, which are fatty alkyls,
ethylene glycol distearate, which is ethylene glycol fatty diester, and
myristyl myristate.

14. A molding method for forming a three-dimensional laminated mold, the molding method comprising the steps of:
ejecting a molten support material from a first inkjet head and solidifying the molten support material, thereby forming a first layer of a support having a first groove;
ejecting a liquid structure material that is an active energy ray-curing compound from a second inkjet head into the first groove;
curing the liquid structure material by irradiating an active energy ray, thereby forming a first layer of a structure;
ejecting the molten support material onto the first layer of the structure and solidifying the molten support material, thereby forming a second layer of the support having a second groove;
ejecting the liquid structure material into the second groove; and
curing the liquid structure material by irradiating the active energy ray, thereby forming a second layer of the structure, wherein
the support material is solid at room temperature and has a ratio of density difference of equal to or less than 13.5%;
the ratio of density difference is calculated from an equation:
ratio of density difference=((D1−D2)/D1)×100
wherein D1 indicates the density of the support material at 20° C., and
D2 indicates the density of the support material at a temperature at which a viscosity of the support material measured using a rotational viscometer falls within the range of 10±1 mPa·s.

15. The molding method according to claim 14, wherein the support material is one of material that melts by active energy ray irradiation and material that deforms by active energy ray irradiation.

16. A molding device for producing a three-dimensional laminated mold, the molding device comprising:
a first inkjet head that ejects a molten support material, wherein the molten support material solidifies to form a support having a groove;
a second inkjet head that ejects a liquid structure material into the groove formed in the support, the liquid structure material being an active energy curing compound; and
a curing device that irradiates the liquid structure material by irradiating an active energy ray, wherein
the molten support material is one of material that melts by active energy ray irradiation and material that deforms by active energy ray irradiation; and
the first inkjet head is located in the vicinity of the curing device.
